(19) United States
(12) Patent Application Publication
(10) Pub. No.: US 2017/0086397 A1
(43) Pub. Date: Mar. 30, 2017

(54) Plant Feeder

(71) Applicant: Keith Robert Sutton, Ontario, NY (US)

(72) Inventor: Keith Robert Sutton, Ontario, NY (US)

(21) Appl. No.: 15/376,548

(22) Filed: Dec. 12, 2016

Related U.S. Application Data
(63) Continuation of application No. PCT/US15/35065, filed on Jun. 10, 2015.
(60) Provisional application No. 62/010,150, filed on Jun. 10, 2014.

(51) Int. Cl. A01G 27/00; A01G 9/12; A01G 9/10

(52) U.S. Cl. CPC A01G 27/005; A01G 9/10; A01G 9/12; A01G 9/104; A01G 9/1073

(57) ABSTRACT

An apparatus includes container having an open top, a lower end portion with a drain opening, and an interior growing space vertically between the open top and the lower end portion. A lid is received over the open top of the container. A plant retainer is supported on the lid, and retains a plant in a growing position in which the stem reaches vertically through the retainer and the roots reach downward from the stem. A plant feeder device is located beneath the retainer to emit water beside the plant. A root trellis reaches across the interior growing space beneath the feeder device. The root trellis has an inner portion aligned vertically with the retainer, an outer portion surrounding the inner portion, and a cross-sectional profile inclined vertically from the inner portion to the outer portion.

### RELATED APPLICATIONS

This application claims the benefit of priority to International Application No. PCT/US2015/035065, filed Jun. 10, 2015, which in turn claims the benefit of priority to provisional U.S. Patent Application No. 62/010,150, filed Jun. 10, 2014, each of which is incorporated by reference.

### TECHNICAL FIELD

This technology includes water-based systems for growing plants.

### BACKGROUND

A water-based system for growing a plant includes a container in which water is provided, and may include a trellis for supporting and suspending the roots of the plant in the container.

### SUMMARY

Each of the following summary paragraphs describes a non-limiting example of how the invention may be implemented as a combination of structural elements disclosed by the detailed description. Any one or more of the elements of each summary paragraph may be utilized with any one or more of the distinct elements of another.

An apparatus may include container having an open top, a lower end portion with a drain opening, and an interior growing space vertically between the open top and the lower end portion. A lid may be received over the open top of the container. A plant retainer may be supported on the lid to retain a plant in a growing position in which the stem reaches vertically through the retainer and the roots reach downward from the stem. A plant feeder device may be located beneath the retainer to emit water beside the plant. A root trellis may reach across the interior growing space beneath the feeder device. The root trellis may have an inner portion aligned vertically with the retainer, an outer portion surrounding the inner portion, and a cross-sectional profile inclined vertically from the inner portion to the outer portion.

An apparatus may include a container having an open top, a lower end portion with a drain opening, and an interior growing space vertically between the open top and the lower end portion. A lid may be received over the open top of the container. A plant retainer may be supported on the lid to retain a plant in a growing position in which the stem reaches vertically through the retainer and the roots reach downward from the stem. A plant feeder device may be located beneath the retainer to emit water beside the plant. A root trellis may reach across the interior growing space. The root trellis may have an inner portion aligned vertically with the retainer, an outer portion surrounding the inner portion, and a cross-sectional profile inclined vertically downward from the inner portion to the outer portion.

An apparatus may include a container having an open top, a lower end portion with a bottom wall and a drain opening, and an interior growing space vertically between the open top and the lower end portion. A lid may be received over the open top of the container. A plant retainer may be supported on the lid to retain a plant in a growing position in which the stem reaches vertically through the retainer and the roots reaching downward from the stem. A plant feeder device may be located beneath the retainer to emit water beside a plant in the growing position. A root trellis may reach across the interior growing space beneath the feeder device; and a support trellis with an open grid configuration may reach upward from the bottom wall to the root trellis.

An apparatus may include a container having an open top with a rim, a lower end portion with a drain opening, and an interior growing space vertically between the rim and the lower end portion. The apparatus may further include a root trellis that reaches across the interior growing space, and a sub-assembly that is movable into and out of an installed position on the open top of the container above the root trellis. The sub-assembly may have interconnected parts separate from the container and the root trellis, including an attachment ring receivable on the rim of the container to mount the sub-assembly in the installed position, a lid to reach over the open top of the container, a plant retainer to retain a plant in a growing position, and a plant feeder device supported on the ring beneath the lid to emit water beside the plant.

An apparatus may include an array of plant growing stations interconnected in a hydraulic circuit. The hydraulic circuit may include a reservoir, a pump, water supply lines reaching from the pump to the growing stations, and water drain lines reaching from the growing stations to the reservoir. A cavitation plate may have a first end supported in the reservoir at a first level, a second end supported in the reservoir at a second level higher than the first level, and a lower side surface reaching upward from the first end toward the second end. An aeration device may be located in the reservoir beneath the cavitation plate. The lower side surface of the cavitation plate may have an undulating contour defined in part by sections of the lower side surface that reach downward in a direction from the first end toward the second end.

An apparatus may include an array of plant growing stations interconnected in a hydraulic circuit with a reservoir, a pump, water supply lines reaching from the pump to the growing stations, and water drain lines reaching from the growing stations to the reservoir. The hydraulic circuit may further include a cooling tower operative to cool water in the circuit.

An apparatus may include an array of plant growing stations interconnected in a hydraulic circuit with a reservoir, a pump, water supply lines reaching from the pump to the growing stations, and water drain lines reaching from the growing stations to the reservoir. The hydraulic circuit may further include a control hub comprising means for treating the water flowing between growing stations.

### BRIEF DESCRIPTION OF THE DRAWINGS

FIG. 1 is a schematic view of a plant growing system including multiple growing stations.

FIG. 2 is a schematic view of an individual growing station in the system of FIG. 1.

FIG. 3 is an exploded view of parts of the growing station of FIG. 2.

FIG. 4 is an enlarged cross-sectional view of parts shown in FIG. 3.

FIG. 5 is a perspective view of a part shown in FIGS. 3 and 4.

FIGS. 6 through 9 are plan views of alternatives for the part shown in FIG. 5.

FIG. 10 is a cross-sectional view of a part configured for use in the growing station of FIG. 2.

FIGS. 11 and 12 are views of alternatives for the part shown in FIG. 10.

FIG. 13 is a perspective view of a component of the system of FIG. 1.

FIG. 14 is perspective view of a part shown in FIG. 13.

FIG. 15 is a side view, partly in cross-section, of parts of the component of FIG. 13.

FIG. 16 is perspective view of a part shown in FIG. 15.

FIG. 17 is a cross-sectional view of a component configured for use in the system of FIG. 1.

FIG. 18 is a cross-sectional view of another component configured for use in the system of FIG. 1.

FIGS. 19 through 22 are views of plant container cover structures.

FIG. 23 is a view of a pipe sheath.

### DETAILED DESCRIPTION

The apparatus shown schematically in the drawings has parts that are examples of the elements recited in the claims. These examples are described here to provide enablement and best mode without imposing limitations that are not recited in the claims.

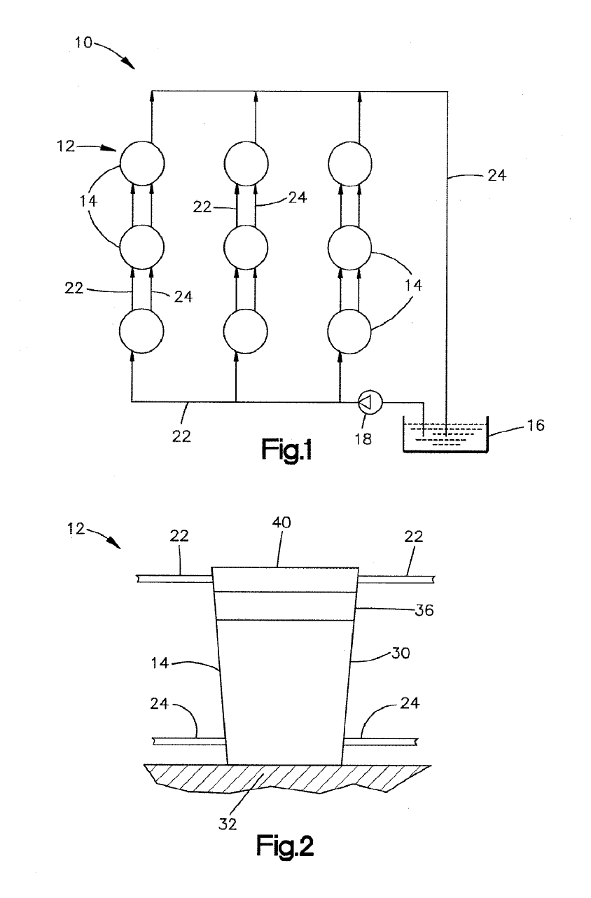

As shown schematically in FIG. 1, a system 10 for growing plants includes an array of plant growing stations 12, each of which includes a container 14. Each container 14 has an interior growing space for a plant. The growing stations 12 are interconnected in a hydraulic circuit with a reservoir 16 and a pump 18. The circuit includes supply lines 22 that receive a pressurized flow of water from the reservoir 16 under the influence of the pump 18, and drain lines 24 that drain water to the reservoir 16 under the influence of gravity.

In the given example, the water supply lines 22 are coupled with each container 14 near the top of the container 14. The water drain lines 24 are coupled with each container 14 near the bottom of the container 14. More specifically, each container 14 has a main body 30 with a bottom wall 32 as shown in FIG. 2. The water drain lines 24 are coupled with the main body 30 near the bottom wall 32. An expansion ring 36 is fitted over the top of the main body 30 to expand its height and volume. A feeder sub-assembly 40 is mounted on the upper end of the expansion ring 36. The water supply lines 22 are coupled with the feeder sub-assembly 40.

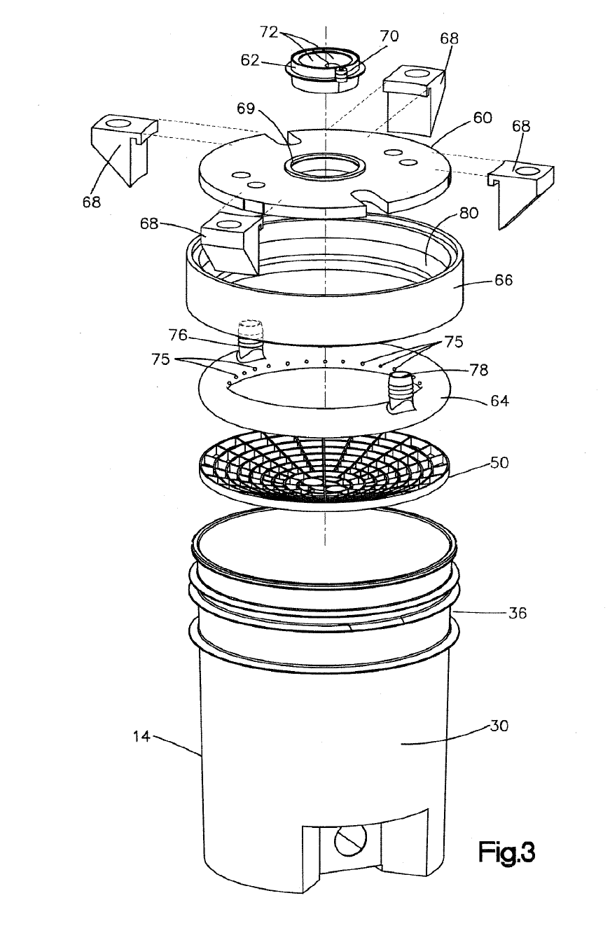

As shown in the exploded view of FIG. 3, each container 14 is equipped with a root trellis 50. The root trellis 50 fits within the container 14 beneath the feeder sub-assembly 40, and may be installed in either the expansion ring 36 or the main body 30 of the container 14. The parts of the feeder-subassembly 40 include a feeder lid 60 and a plant retainer 62. Other parts of the sub-assembly 40 include a feeder ring 64 and an attachment ring 66. Upper trellis support clips 68 also may be provided.

The lid 60 is sized and shaped to close the upper end of the growing station 12, and has a central aperture 69 for receiving and supporting the retainer 62 at that location. The retainer 62 is a bisected circular device with a hinge 70 supporting its two halves for movement pivotally into and out of the closed condition shown in the drawings. A pair of elastomeric parts 72 of the retainer 70 are thus movable together to clamp against a plant stem, and thereby to retain the plant in a growing position with the stem reaching vertically through the retainer 62 and the roots reaching downward from the stem. The roots are thus suspended in the growing space inside the container 14.

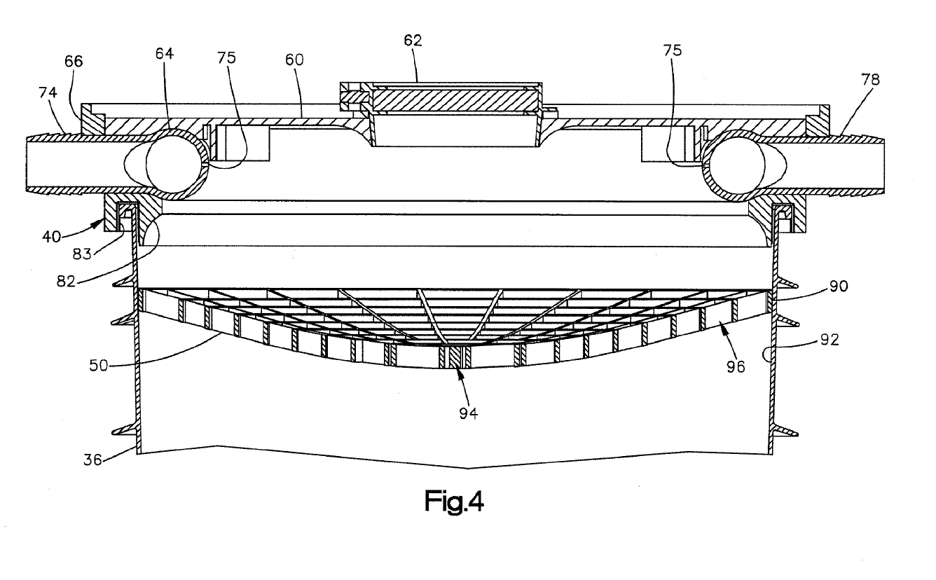

The feeder ring 64 is a water line with outlet ports 75 for discharging a mist of water and nutrients radially inward beside a plant in the growing position. A inlet stub 76 on the ring 64 receives a flow of water from the upstream supply line 22 to which it is coupled as shown in FIG. 2. An outlet stub 78 on the ring 64 discharges the bulk of the flow to the downstream supply line 22 and onward to the next growing station 12 in the hydraulic circuit of FIG. 1. Although the stubs 76 and 78 are shown to project axially from the ring 64 in FIG. 3, they may alternatively project radially from the ring 64 as shown in FIG. 4.

As further shown in FIG. 4, the lid 60, the retainer 62, the feeder ring 64 and the attachment ring 66 are interconnected separately from the container 14 and the root trellis 50. The lid 60 rests on the attachment ring 66. A radially inner surface 80 (FIG. 3) of the attachment ring 66 is a seat for the feeder ring 64 to be installed within the attachment ring 66 beneath the lid 60, as shown in FIG. 4. Another inner surface 82 of the attachment ring 66 has a concave arcuate profile facing radially inward beneath the feeder ring 64. That inner surface 82 can serve as a water control surface that deflects water downward from the attachment ring 66. A peripheral notch 83 at the bottom of the attachment ring 66 is fitted over the rim 84 at the top of the expansion ring 36 on the container 14.

In the cross-sectional view of FIG. 4, the given example of a root trellis 50 is shown as generally disk-shaped with a domed or bowed radial profile. An outer edge surface 90 of the trellis 50 is press-fitted against the surrounding inner wall surface 92 of the expansion ring 36. In this arrangement, the trellis 50 has central portion 94 aligned vertically with the retainer 62, a peripheral portion 96 surrounding the central portion 94, and an arcuate cross-sectional profile inclined vertically from the central portion 94 to the peripheral portion 96.

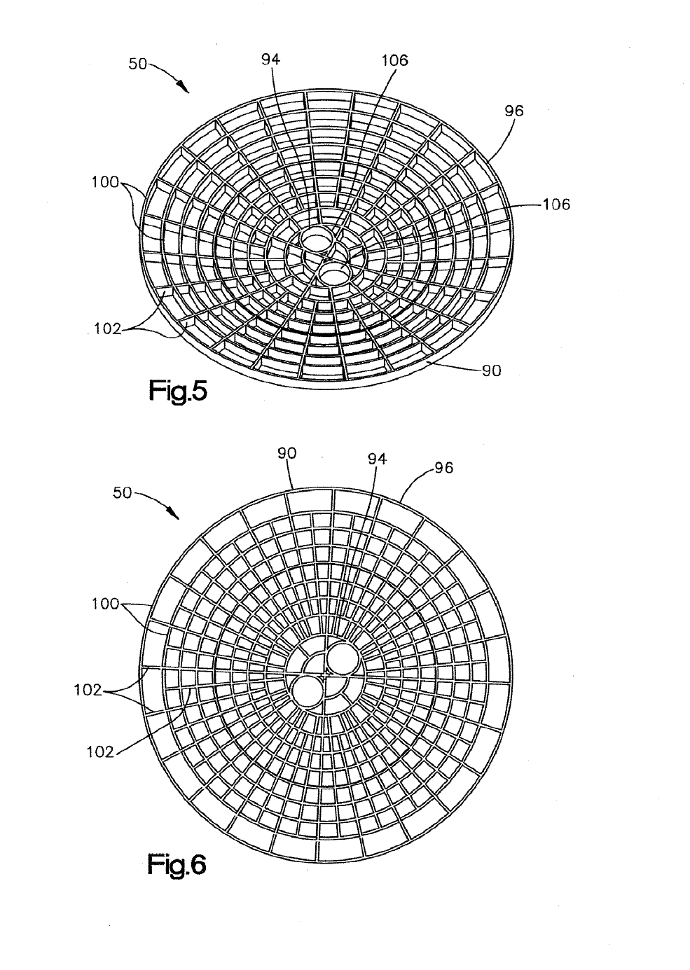

In the perspective view of FIG. 5, this example of the root trellis 50 is shown as an open grid configured as an array of concentric circular ribs 100 that are interconnected by spoke-like arms 102. The ribs 100 are equally spaced apart radially. The arms 102 reach radially from the central portion 94 of the trellis 50 to the outermost rib 100 at the peripheral portion 96, and are equally spaced apart circumferentially. A pair of smaller circular ribs 106 may be provided at the central portion 94 to define finger holes for grasping and handling the trellis 50.

Although the trellis 50 in the illustrated example is shown with its concave side facing upward, it could alternatively be installed in the container 14 with its convex side facing upward. In either case, the inclined configuration of the cross-sectional profile places the ribs 100 in a vertically staggered relationship. Specifically, the top of each rib 100 is lower than the top of an adjacent rib 110, and is higher than the top of the other adjacent rib 110. This vertical staggering between adjacent ribs 100 provides a ladder-like platform that promotes growth of the roots horizontally outward across the tops of the ribs 100.

Other examples of an open grid configuration for the trellis 50 are shown in FIGS. 6-9. The configuration of FIG. 6 includes additional arms 102 reaching only partially between the central portion 94 to the outermost rib 100. This provides a more densely concentrated array of ribs 100 and arms 102 for encouraging root growth radially outward across the trellis 50 toward the peripheral portion, at which the roots are more freely able to descend from the trellis 50 into the growing space beneath.

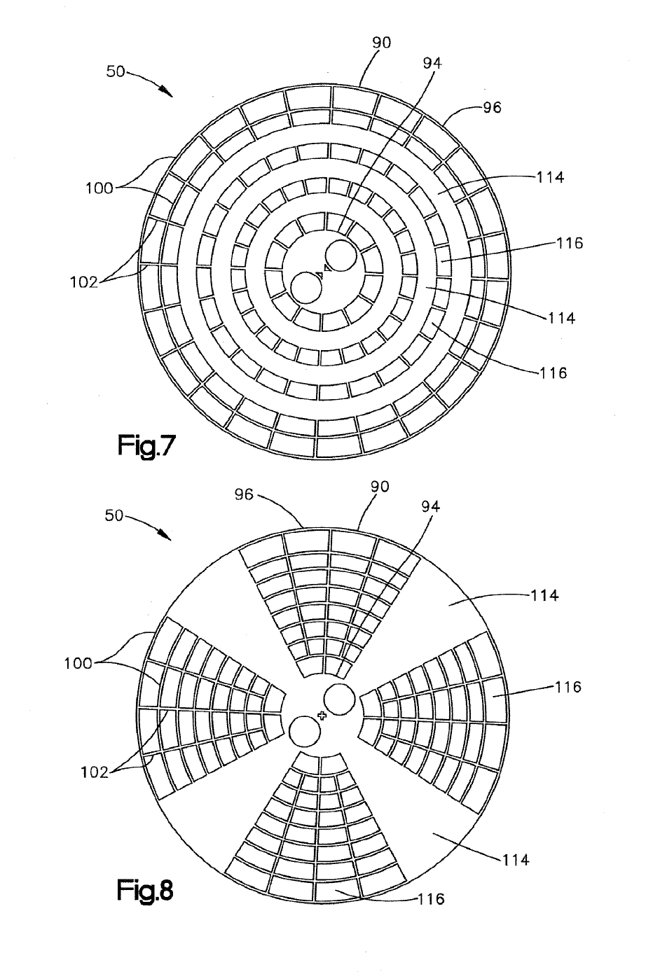

FIGS. 7 and 8 show patterns of closed surface areas 114 that encourage horizontal growth by blocking the roots from reaching downward through the trellis 50 at those locations. The pattern of FIG. 7 includes closed surface areas 114 in concentric circular shapes radially between concentric circular open grid areas 116. The pattern of FIG. 8 includes closed surface areas 114 shaped as segments of the overall circular shape of the trellis 50. Those closed areas 114 project radially outward between open grid areas 116 that are likewise shaped as radial segments. The pattern of FIG. 9 includes a non-symmetrically distributed array of closed surface areas 114.

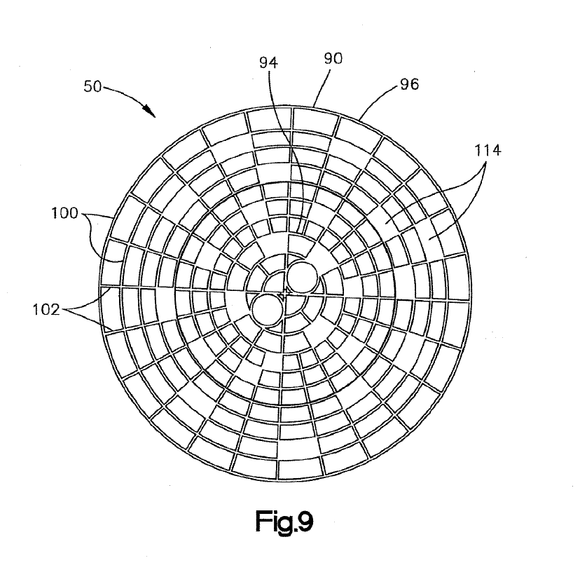

As noted above, the root trellis 50 of FIG. 4 is press-fitted within the container 14. In other embodiments, the container 14 may be equipped with a support trellis 120 that supports the root trellis 50 from beneath, either with or without the press fit. Such a support trellis 120 would also have an open grid configuration, and would preferably reach fully upward from the bottom wall 32 of the container 14 to the underside of the root trellis 50. The support trellis 120 could have a tubular configuration as shown in FIG. 10. Other suitable cross-sectional configurations include and X shape as shown in FIG. 11 and a star shape as shown in FIG. 12.

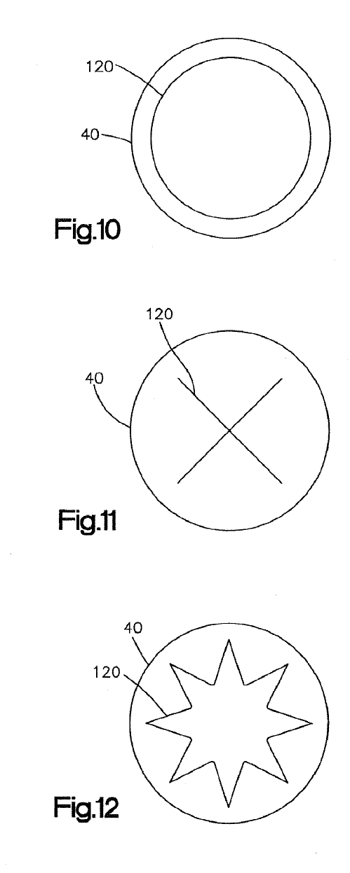

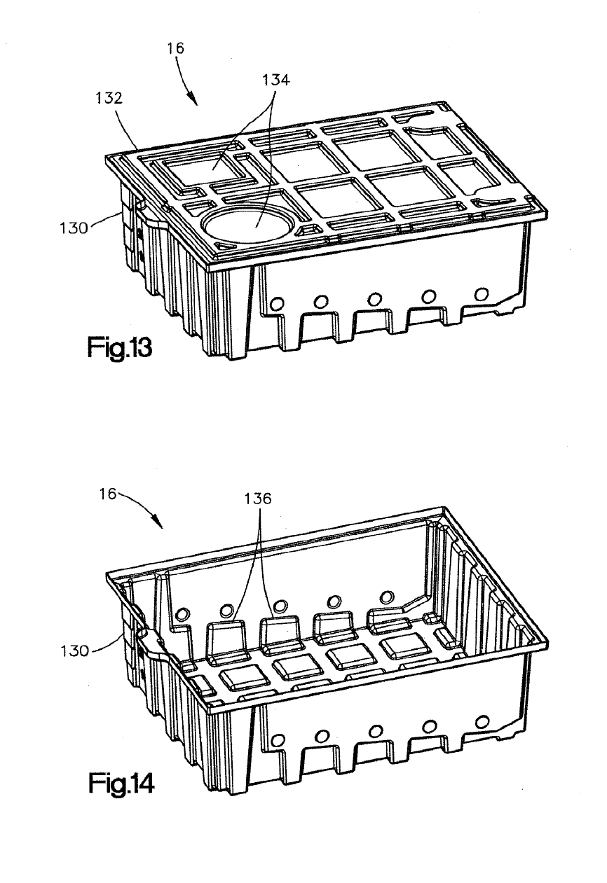

The reservoir 16 is shown in greater detail in FIG. 13. This example includes a rectangular tray-shaped body 130 with a flat lid 132. Recessed areas 134 of the lid 132 can be punched out to provide access holes. As shown in FIG. 14, inclined shoulder surfaces 136 reach along the opposite side walls of the body 130. The shoulder surfaces 136 are arranged to support a cavitation plate 140 in the installed position shown in FIG. 15. As shown separately in FIG. 16, the cavitation plate 140 also is shaped as a rectangular tray, and has a bottom wall 142 with an undulating contour.

When the cavitation plate 140 rests on the shoulder surfaces 136 in the body 130 of the reservoir 16, the lower side 144 of the bottom wall 142 is inclined as shown in FIG. 15. Although the lower side 144 as a whole reaches upward from its lower end 146 toward its upper end 148, the undulating contour provides individual sections 150 that reach downward in the same direction. This provides a vertically undulating path for bubbles from an aeration device 156, such as an air stone, to traverse from one end of the reservoir 16 to the other. This promotes aeration of the water, which normally fills the reservoir 16, also helps to keep nutrients in suspension by inducing a flow of the water end-to-end over and under the cavitation plate 140.

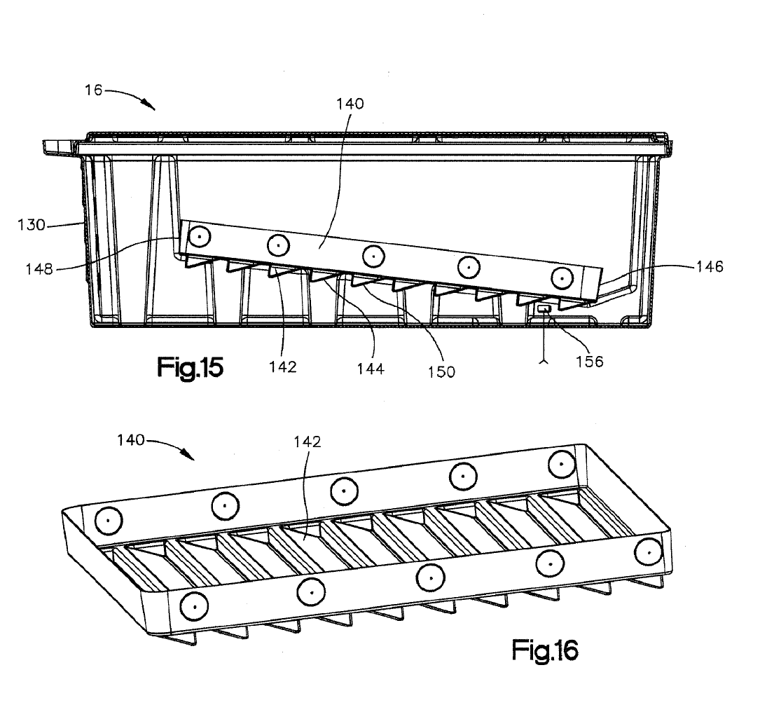

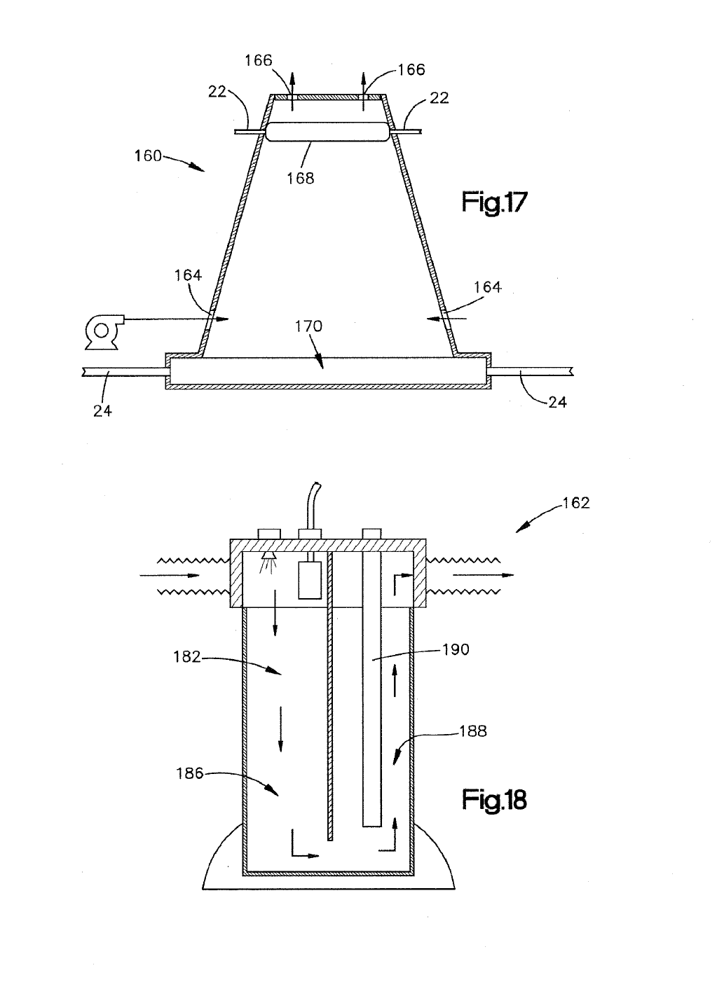

In addition to the components shown in FIG. 1, the system 10 may further include one or more cooling towers 160 (FIG. 17), and/or one or more control hubs 162 (FIG. 18).

In the example of FIG. 17, the cooling tower 160 has a generally conical shape with air inlets 164 near its lower end and air outlets 166 at its upper end. A water feed ring 168 near the upper end is connected in the water supply lines 22. A collection basin 170 at the lower end is connected in the drain lines 24. A blower system 172 drives a flow of cooling air inward through the inlets 164, upward through a mist of water descending from the water feed ring 168, and outward through the outlets 166. This cools and aerates the water as it flows through the system 10.

In the example of FIG. 18, the control hub 162 has a pressure chamber 182. A baffle 184 separates the chamber 184 into inlet and outlet columns 186 columns 188 of equal height so water can flow through the chamber 182 in the downstream flow path reaching through the supply lines 22. One or more or more water quality detection/treatment devices are operatively located in the chamber 182. Such devices may include for example, a heater 190 as shown schematically in FIG. 18, and/or one or more of the following components; heater, cooling equipment, air stones, PH/fertilizer adjusting and monitoring equipment, ultra-violet light bulb, ozone generating equipment, test ports, filter, charcoal pads or bags, and water sensor and monitoring equipment, water pressure sensing or adjustment equipment, ion measuring or adjusting equipment, thermometer, water quality test port, internal or external bypass valve. The control hubs 162 can have a flow through design to allow their use anywhere in the system 10. In some examples, multiple control hubs 162 can be connected to the system 10. For example, control hubs 162 can be connected in a daisy-chain configuration. In some examples of the control hub 162, the components can be wired. In some examples of the control hub 162, the components can be radio transmitted.

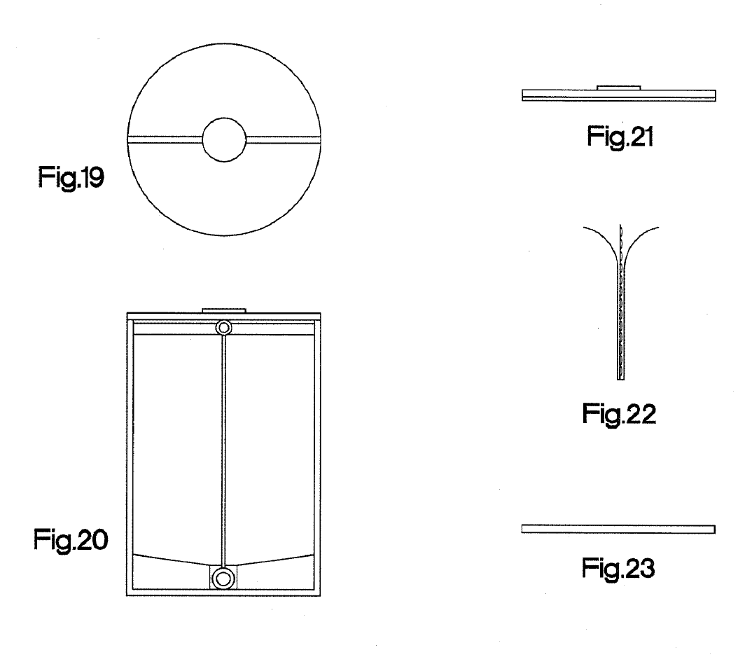

FIGS. 19 through 23 disclose examples of a plant container cover. In some examples, the plant container cover can provide thermal protection. In some examples, the plant container cover can provide ultra-violet light protection. In some configurations, the plant container cover can protect against the degradation of plant containers, reservoirs, plant feeder system and pipes. In some examples, the plaint container cover can reduce noise levels. In some examples, the plant container cover can reduce energy costs. In some examples, the plant container cover can reduce water evaporation.

In some examples, the plant container cover can include a plant container cover lid and plant container cover sides. In some examples, the plant container cover lid can include a hole for a plant retainer. In some examples, the plant container cover can be comprised of two halves, including two halves for the plant container cover lid and two halves for the plant container cover sides. In some examples, the two halves of the plant container cover can be removeably attached, for example, with a fastener such as a hook and loop fastener. In some examples, the plant container cover lid can fit the two dimensional shape of the plant container lid, for example, the plaint container cover lid can fit a plant container lid that is round, oval, square, rectangular, or triangular, among other shapes. In some examples, the plaint container cover sides can fit the three dimensional shape of the plant container, for example, the plaint container cover can fit a plant container that is spherical, egg-shaped, box-shaped, or prism-shaped, among other shapes. The plaint container cover can further include a drain line opening configured to accommodate a drain line, suction line, supply line, power cords, and airline. Plant container covers can have various holes for adjustment equipment, monitoring equipment cameras, inspection covers, and droplet size measurement equipment.

FIG. 22 is a cross-section of a plant container cover. As show, in some examples the plant container cover can be comprised of multiple layers. In some examples the plant container cover can include a reflective layer configured to reflect sunlight and ultra-violet light. In some examples the plant container cover can include a layer of insulating material configured to hold heat in or keep heat out. For example, the insulating material could be bubble insulation or foil. In some examples, the insulating material can be a foam insulating material. In some examples, the plant container cover can include a dark layer, configured to block light. The plant container cover can prevent algae growth with the use of white plastic plant containers and piping in some examples. In some examples the plant container cover can be figured such that the reflective layer is on the outside, the dark layer is on the inside, and the insulating layer is in between. In some examples the plant container cover can be reversed such that the dark layer is on the outside and the reflective layer is on the inside.

FIG. 23 is a side view of a pipe sheath. In some examples, the pipe sheath can be made of the materials and comprising the layers as described with respect to the plant container cover. In some examples, the pipe sheath can be reversible. The pipe sheath can have the same features as described with respect to the plant container covers.

This written description sets for the best mode of carrying out the invention, and describes the invention so as to enable a person skilled in the art to make and use the invention, by presenting examples of elements recited in the claims. The patentable scope of the invention is defined by the claims, and may include other examples that occur to those skilled in the art. Such other examples, which may be available either before or after the application filing date, are intended to be within the scope of the claims if they have elements that do not differ from the literal language of the claims, or if they have equivalent elements with insubstantial differences from the literal language of the claims.

What is claimed is:

1. An apparatus comprising:
a container having an open top, a lower end portion with a drain opening, and an interior growing space vertically between the open top and the lower end portion;
a lid received over the open top of the container;
a plant retainer supported on the lid and configured to retain a plant in a growing position with a stem reaching vertically through the retainer and roots reaching downward from the stem;
a plant feeder device located beneath the retainer and configured to emit water beside a plant in the growing position; and
a root trellis reaching across the interior growing space beneath the feeder device, the root trellis having a first portion aligned vertically with the retainer, a second portion surrounding the first portion, and a cross-sectional profile inclined vertically from the first portion to the second portion.

2. An apparatus as defined in claim 1 wherein the cross-sectional profile of the root trellis is inclined vertically downward from the first portion to the second portion.

3. An apparatus as defined in claim 1 where the cross-sectional profile of the root trellis has an arcuate configuration between the first portion and the second portion.

4. An apparatus as defined in claim 1 wherein the first portion of the root trellis is a central portion, and the second portion of the root trellis is a peripheral portion.

5. An apparatus as defined in claim 4 wherein the root trellis comprises an open grid defined by circular ribs and arms that reach radially across the ribs from central portion to the peripheral portion, including arms that reach radially across the peripheral portion and arms that do not reach radially across the peripheral portion.

6. An apparatus as defined in claim 1 wherein the root trellis comprises a grid having open grid areas with openings for roots to descend through the trellis, and further having closed areas interposed between the open grid areas to block roots from descending through the trellis at the closed grid areas.

7. An apparatus comprising:
a container having an open top, a lower end portion with a drain opening, and an interior growing space vertically between the open top and the lower end portion;
a lid received over the open top of the container;
a plant retainer supported on the lid and configured to retain a plant in a growing position with a stem reaching vertically through the retainer and roots reaching downward from the stem;
a plant feeder device located beneath the retainer and configured to emit water beside a plant in the growing position; and
a root trellis reaching across the interior growing space, the root trellis having a first portion aligned vertically with the retainer, a second portion surrounding the first portion, and a cross-sectional profile inclined vertically downward from the first portion to the second portion.

8. An apparatus as defined in claim 7 where the cross-sectional profile of the root trellis has an arcuate configuration between the first portion and the second portion.

9. An apparatus as defined in claim 7 wherein the first portion of the root trellis is a central portion, and the second portion of the root trellis is a peripheral portion.

10. An apparatus as defined in claim 9 wherein the root trellis comprises an open grid defined by circular ribs and arms that reach radially across the ribs from central portion to the peripheral portion, including arms that reach radially across the peripheral portion and arms that do not reach radially across the peripheral portion.

11. An apparatus as defined in claim 7 wherein the root trellis comprises a grid having open grid areas with openings for roots to descend through the trellis, and further having closed areas interposed between the open grid areas to block roots from descending through the trellis at the closed grid areas.

12. An apparatus comprising:
a container having an open top, a lower end portion with a bottom wall and a drain opening, and an interior growing space vertically between the open top and the lower end portion;
a lid received over the open top of the container;
a plant retainer supported on the lid and configured to retain a plant in a growing position with a stem reaching vertically through the retainer and roots reaching downward from the stem;
a plant feeder device located beneath the retainer and configured to emit water beside a plant in the growing position;
a root trellis reaching across the interior growing space beneath the feeder device; and
a support trellis having an open grid configuration and reaching upward from the bottom wall to the root trellis.

13. An apparatus as defined in claim 12 where the support trellis is tubular.

14. An apparatus as defined in claim 12 wherein the support trellis has a non-circular cross-sectional shape.
